(19) United States
(12) Patent Application Publication
(10) Pub. No.: US 2013/0319703 A1
(43) Pub. Date: Dec. 5, 2013

(54) TOOL MOUNTING ASSEMBLY AND TOOL HOLDER THEREOF

(71) Applicant: Allan J. Yeomans, Surfers Paradise (AU)

(72) Inventor: Allan J. Yeomans, Surfers Paradise (AU)

(21) Appl. No.: 13/909,186

(22) Filed: Jun. 4, 2013

(30) Foreign Application Priority Data
Jun. 5, 2012 (AU) 2012902331

(51) Int. Cl. A01B 15/02

(52) U.S. Cl. CPC A01B 15/02
USPC 172/744

(57) ABSTRACT

A tool mounting assembly for mounting an earth working tool to a shank or tyne, the shank or tyne having opposite side surfaces and the tool mounting assembly including a tool holder having an opening for slidably receiving the shank or tyne and the holder having means for cooperating with one or both side surfaces of the shank to prevent or minimize lateral twisting movement of the holder relative to said shank or tyne. Such means may comprise a surface which defines with a side surface of the shank a tapering space for receiving soil, dirt or other particulate material which in use becomes wedged between the holder and the side surface or surfaces of the shank or tyne. In another arrangement, a resilient wire, rod or other wedging member is received within the tapering space. In yet a further arrangement, the holder includes at least one clamping screw which can be advanced into engagement with the adjacent side surface of the shank to clamp the holder laterally to the shank. The present invention also provides a tool holder for use in the tool mounting assembly.

### TECHNICAL FIELD

The present invention relates to a tool mounting assembly for the mounting of a ground or earth working tool to a shank or tyne of earth working or agricultural equipment. In a further aspect, the present invention provides a tool holder for use in the tool mounting assembly.

### BACKGROUND OF THE INVENTION

It is common practice to mount the shanks or tynes of earth working tools to tool bars of agricultural equipment associated with or towed by a tractor or other prime mover. It is also known to attach various different working tools to such shanks or tynes for working of the soil or for weeding rearwardly of the shank or tyne. Such tools may for example comprise cutting knifes or blades or other subsoiling tools. It is desirable that the tools which are attached to the shanks or tynes be capable of simple vertical adjustment along the shank or tyne to allow for the attached tools to be adjusted for different depths of operation. It is also desirable however to have a mounting system for such tools which firmly attaches the tool to the shank or type to hold the tool firmly in place in a desired position when using the shank and coupled tool in the ground.

Various types of tools can be attached to shanks or tynes and in many cases the attached tools for example cutting tools can have considerable lateral span to either side of the shank. Tools of this type tend to apply twisting loads to the tool mounting system and thus to the shank. To avoid failure of the mounting system between the tool and the shank or tyne, it is important that the mounting system is secure and does not become loose under load. It is preferred also that the mounting system enables easy adjustment of the attached tool along the shank or tyne.

A common arrangement for attaching various tools to a shank or tyne is to form in the shank itself, a series of holes to which tools can be attached by bolts. The vertical adjustment of such tools however is time consuming. Further, the formation of such holes generally reduces the strength of the shank. In another arrangement serrated tracks are formed in the rear of the shank or tyne to which tools are mounted by damping two cheek plates to the track. These cheek plates are difficult to keep tight when subject to inevitable asymmetrical side loads.

In my U.S. Pat. No. 4,976,566, I disclose a system for mounting an earth working tool to a shank or tyne which comprises a substantially vertical track on the rear of the shank and a tool holder which is adapted to fit over the track. A wedge member which is adapted for wedging between the track and the tool holder is provided to enable the holder to be secured to the shank at a selected position along the shank to enable adjustment of the vertical height of the tool holder and the tool mounted to the tool holder. This system allows for rapid adjustment of the height of the earth working tool however because there must be sufficient clearance between the holder and shank to allow the holder to move longitudinally relative to the shank when being adjusted, there still tends to be a wobbling or lateral twisting movement between the shank and holder when the tool is subject to loads which can cause excessive wear and possible failure of the mounting system.

It would be desirable if a tool mounting assembly and a tool holder was available which addressed one or more of the above disadvantages or at which provided an alternative to the presently known tool mounting assemblies or systems.

### BRIEF SUMMARY OF INVENTION

According to one preferred aspect, the present invention provides a tool holder for mounting a ground or earth working tool to a shank or tyne, said shank or tyne having opposite side surfaces, said tool holder having an opening therethrough adapted to receive the shank or tyne, and wherein said holder includes means adapted to cooperate with at least one said side surface of said shank to prevent or minimize lateral twisting movement of said holder relative to said shank or tyne.

Preferably, the holder includes at least one surface which defines in use with a side surface of the shank a tapering space adapted to receive a material or member which in use is or becomes wedged between the holder and at least one side surface of the shank or tyne to prevent or minimize lateral twisting movement of the holder relative to the shank.

In one embodiment, the holder includes a surface which is angled outwardly in a longitudinal direction relative to the longitudinal axis of the opening (and to a central longitudinal plane of the holder which contains the opening axis) to define in use with a side surface of the shank, the tapering space. Preferably the holder includes angled surfaces on opposite sides to define respective tapering spaces with the respective side surfaces of the shank on opposite sides thereof. The or each angled surface is suitably defined in a recess or rebate in an inner surface or surfaces of the holder which is/are adjacent a side surface or surfaces of the shank or tyne in use.

Preferably the holder has at least one upper recess or rebate which opens to and communicates with a normally upper side of the holder so as to enable the material or member to enter the tapering space defined by the angled surface of the recess. Preferably the holder has a pair of recesses or rebates on opposite sides thereof having the respective angled surfaces. The at least one recess or rebate also suitably tapers in width from a maximum at its lower end to a minimum at its upper end.

The holder may also have at least one lower angled surface which is angled in a similar manner to the upper surface or surfaces, that is angled outwardly relative to the longitudinal axis of the opening and central longitudinal plane of the holder to define in use with a side surface/s of the shank or tyne, a further tapering space or spaces. Preferably the at least one lower surface is provided in at least one lower recess or rebate which is below the upper recess or recesses. An opening may be provided adjacent an upper end of the lower angled surface to provide communication between the upper end of that tapering space and the outside of the holder to permit the material/member to enter the tapering space/s defined between the lower recess or recesses and side surface/s of the shank or tyne. The at least one lower recess or rebate also tapers in width from a maximum at its upper end to a minimum at its lower end.

Typically the material or member which locates within the tapering space comprises soil, dirt or other particulate material from the earth or ground in which the tool is working which will enter the space's because the holder will normally be located below the upper level of the earth or ground. Any movement between the holder and shank will cause soil, dirt or other particulate material to move downwardly in the tapering space's to increase the wedging effect between the holder and shank.

In another embodiment, the holder includes at least one surface which is angled to the central longitudinal plane of the holder through the passage opening in a fore and aft direction, the angled surface defining in use with a side surface of the shank a space which tapers in cross-section in the fore and aft direction. Preferably the surface is angled such that the space tapers in cross section from a minimum to a maximum towards the leading end of the holder relative to the normal direction of movement of the holder. The tapering space in this embodiment is adapted to receive a wedging member for wedging between the holder and shank

Preferably the tapering space in this embodiment is adapted to receive a wedging member which in use is interposed between the angled surface and the adjacent side surface of the shank or tyne. Preferably the wedging member is an elongated member, suitably a resilient member. Preferably the wedging member is a wire or rod. Preferably the member is arranged such that its inherent resilience urges the member towards a wedging position within the tapering space.

Preferably the holder includes upper and lower tapering spaces of the above described type and the wedging members extends from one tapering space to the other tapering space. Preferably the wedging member is resiliently stressed when in position extending from the one tapering space to the other tapering space and has opposite end portions which define respective legs located in the respective tapering spaces. The legs of the wedging member when in the respective upper and lower space are usually arranged at an obtuse angle to each other. Preferably the resilience of the wedging member resiliently urges the respective legs towards a wedging position. Thus should the tapering space/s increase in size due to relative movement between the holder and shank, the resilience of the wedging member will cause the legs of the wedging member to move further towards a wedging position in the tapering space/s to maintain the wedging action. Typically pairs of upper and lower tapering spaces are located on opposite sides of the holder to receive respective resilient wedging members which are located in use between the holder and shank on opposite sides thereof to prevent or minimize lateral movement between the holder and shank.

In another embodiment, the holder includes or carries at least one clamping screw adapted to be advanced into engagement with the adjacent side surface of the shank. Preferably the holder captures a nut with which the clamping screw is threadably engaged. Preferably the nut is captured against rotation in a recess in the holder. Preferably respective clamping screws are provided on opposite sides of the holder for engagement with opposite side surfaces of the shank or tyne.

A tool holder may include one or more of the above described arrangements for preventing or minimizing lateral movement between a holder and tyne. Preferably the holder includes a pair of side arms or flanges which are parallel to the central longitudinal plane and which include or carry the respective angled surfaces and/or captured nuts. The opening for receiving the shank or tyne is provided between the side arms and the side arms in use are located on respective opposite sides of the shank or tyne.

Preferably, means are provided for securing the holder to the shank or tyne at a selected position along the shank or tyne. The tool shank or tyne may include a track extending along a rear side thereof and the opening in the holder is adapted to receive and capture the shank or tyne track. Preferably the means for securing the holder to the shank or tyne at a selected position along the shank comprises a wedging member adapted to be located in the opening to be wedged between the holder and shank or tyne. Preferably the tool holder is adapted to support a pivot pin for pivotally connecting a tool via the tool holder to the shank or tyne. Preferably the tool holder includes upper and lower rearwardly extending flanges and the pivot pin extends between the flanges. Suitably, the axis of the pivot pin lies in the central longitudinal plane through the holder.

The present invention in a further aspect provides a tool mounting assembly for mounting a ground or earth working tool to a shank or tyne, said tool mounting assembly comprising a tool holder having an opening therethrough adapted to received the said shank or tyne, and means adapted to be located between said holder and at least one said side surface of said shank to prevent or minimize lateral twisting movement of said holder relative to said shank or tyne. The means for preventing or minimizing the lateral twisting movement of the holder may include one or more of the above described arrangements and comprise a material or member which in use is or becomes wedged between the holder and at least one side surface of the shank or tyne to prevent or minimize lateral twisting movement of the holder relative to the shank.

The tool holder may include at least one surface which defines in use with a side surface of the shank a tapering space adapted to receive the wedging material or member. The tool holder may includes at least two such surfaces which define in use with a side surface of the shank, at least two tapering spaces, a first said tapering space tapering in the direction from an upper end of the holder towards a lower end thereof and a second tapering space tapering in a fore and aft direction relative to a front and rear of the holder. The first tapering space is suitably adapted to receive a particulate material such as dirt or soil and the second tapering space is suitably adapted to receive the wedging member.

The present invention in yet a further aspect provides in combination a tool shank or tyne and a tool holder, said tool holder being adapted to cooperate with at least one side surface of said shank or tyne to prevent or minimize lateral twisting movement of said holder relative to said shank or tyne. The means for preventing or minimizing the lateral twisting movement of the holder may include one or more of the above described arrangements. Preferably, means are provided for releasably securing the holder to the shank or tyne at a selected position along the shank or tyne.

### BRIEF DESCRIPTION OF THE DRAWINGS

Reference will now be made to the accompanying drawings which illustrate a preferred embodiment of the invention and wherein:

FIGS. 1 and 2 are opposite isometric views of the tool holder of a tool mounting assembly for mounting a tool to a shank or tyne;

FIG. 3 is a side view of the tool holder;

FIG. 4 is a side view of portion of a tool shank or tyne carrying the tool holder;

FIG. 4A is an enlarged isometric view of a wedging member for securing the tool holder along the tyne or shank;

FIGS. 5 is a top view of the tool holder engaged with a tool shank or tyne (shown in cross section);

FIG. 6 is a longitudinal sectional view through the central longitudinal plane of the tool holder along line A-A of FIG. 5 and showing a resilient wedging member; and

FIG. 7 is a sectional view of the tool holder along line B-B of FIG. 5 showing the tool holder mounted to a tool shank (in cross section) and showing soil or other granular or particulate material forming wedges.

### DETAILED DESCRIPTION OF THE EMBODIMENT

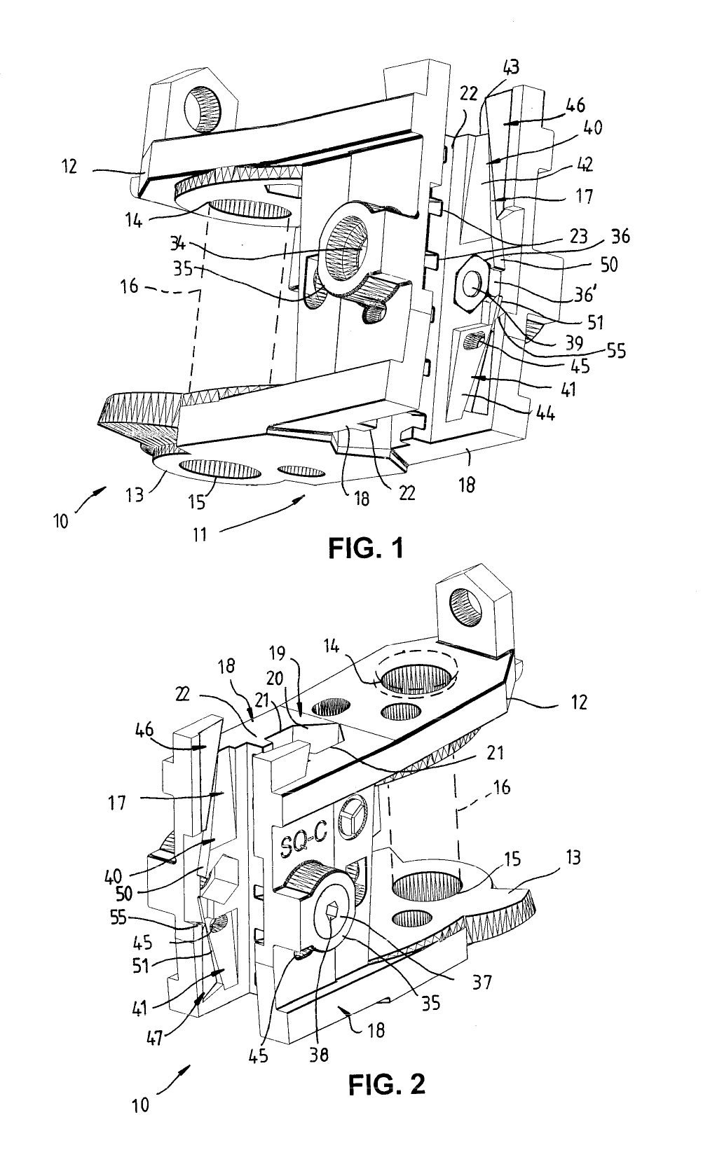

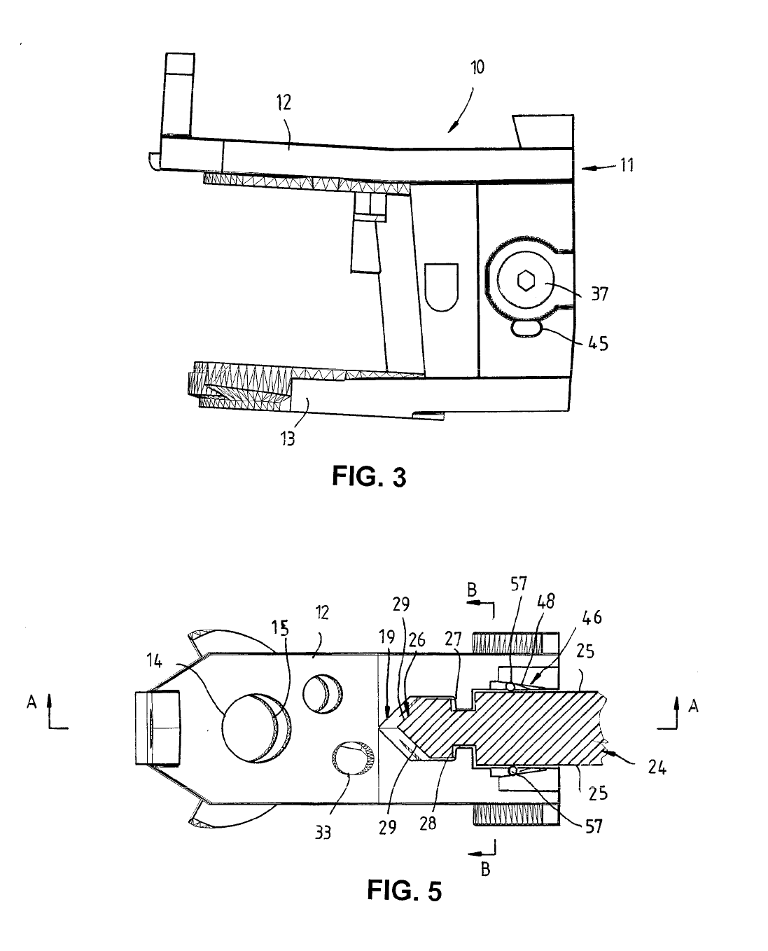

Referring to the drawings and firstly to FIGS. 1 to 3, there is illustrated a tool holder 10 of a tool mounting assembly according to an embodiment of the invention, the holder 10 comprising a main holder body 11 and upper and lower flanges 12 and 13 extending rearwardly therefrom, the flanges 12 and 13 having circular holes or openings 14 and 15 therein which are aligned with each other to receive a pivot pin 16 (shown in dotted outline) through which a wide variety of ground or earth working tools and equipment common in earth, working and agricultural may be attached to the holder 10, the tool when connected to the pivot pin 16 being capable of pivotal movement about the pivot pin 16. Typically the tool may comprise a cutting blade assembly with blades of a V-shaped configuration however it, will be appreciated that a large range of different tools may be connected to the tool holder 10 via the pivot pin 16 and the term “ground or earth working tools” as used throughout the specification and claims includes all such tools.

The holder body 11 also includes an inwardly extending elongated slot or opening 17 which extends the full length of the body 11 to open at the top and bottom thereof for receipt of a tyne or shank of an earth working tool as described further below. The slot or opening 17 has a longitudinal axis X-X (see FIG. 7) and lies in the central longitudinally extending plane of the holder 10 which contains the pivot pin 16 and is defined between opposite side arms 18 of the holder body 11. The opening 17 includes a trailing portion 19 which is of a generally C-shaped cross section and which has a rearward V-shaped inside surface 20. The V-shaped inside surface 20 of the trailing portion 19 of the opening 17 is sloped or angled slightly forwardly from the top to the bottom of the holder body 11. The trailing portion 19 of the slot or opening 17 also includes opposite side surfaces or walls 21 which extend between the V-shaped inside surface 20 and a pair or opposite inwardly directed flanges 22. The flanges 22 have spaced depressions or grooves 23 along their length to provide for secure mounting to a tyne as will become apparent further below. The opposite side arms 18 of the slot or opening 17 are substantially parallel to one another and are spaced apart a distance slightly greater than the distance between the opposite sides of a shank 24 to be received in the passage 17 as illustrated in FIG. 5 such that a clearance exists between the shank 24 and arms 18 which enables the shank 24 to be moved relatively freely longitudinally relative of the slot or opening 17 as described further below until it is secured in position.

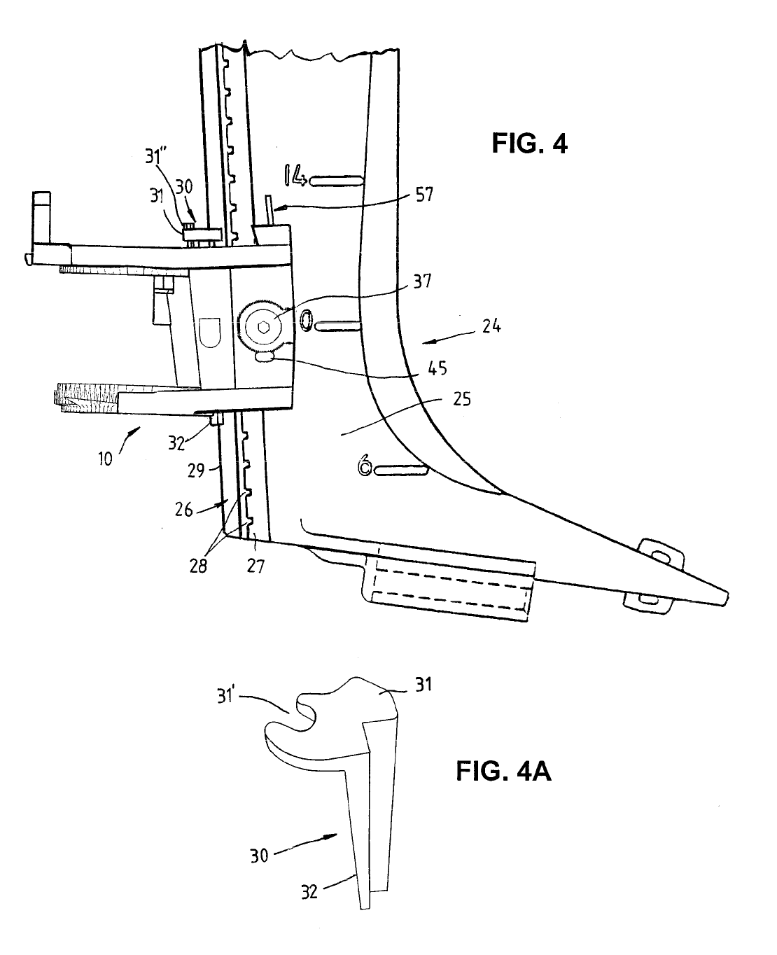

The shank 24, which may be suitably secured at its upper end to, for example, a tool bar of an earthworking or agricultural device, is shown in FIGS. 4 and 5 and has a pair of opposite side surfaces 25 and at its rearward end, a track 26 substantially in the shape of an arrowhead and complementary to the C-shaped trailing portion 19 of the slot or opening 17. Although the track 26 as shown is integrally formed with the shank 24, it could also be separately manufactured and then attached to an existing shank such as by welding. The track 26 has opposite forward facing side edges or ribs 27 which have spaced protrusions 28 which are adapted to mate with the depressions or grooves 23 on the holder flanges 22.

The track 26 is narrower than the distance between the side surfaces or walls 21 of the trailing portion 19 of the holder slot or opening 17 to permit full longitudinal movement of the holder 10 relative to the track 26. A substantial clearance is provided between the rear surfaces 29 of the track 26 and the rear surfaces 20 of the trailing portion 19 of the opening 17 so that when the slot portion 19 is positioned over the track 26, a gap is provided to permit the insertion of a wedge member 30. The wedge member 30 as also shown in FIG. 4A is preferably formed with a top plate 31 at its upper end and has a leg 32 of V-shaped cross section on opposite sides for cooperation with and wedging between the rear surfaces 20 of the opening 19 and the angled rear side surfaces 29 of the track 26. Such an arrangement is similar to that described in my aforementioned U.S. Pat. No. 4,976,566. The top plate 31 may also be provided with a hole or slot 31 therethrough for receipt of a bolt 31″ passed through an opening 33 in the upper flange 12 of the holder 10 for urging the wedge member 30 longitudinally of the opening 17 for tightly securing the holder 10 to the shank 24 at a set position therealong defined by the cooperating protrusions and grooves 28 and 23 which mate with each other.

As referred to above, the side arms 18 of the holder body 11 are spaced apart a distance slightly greater than the distance between the side surfaces 25 of the shank 24 which the arms 18 overlie when the holder 10 is mounted to the shank 24 as is apparent in Fig, 5. Central transversely extending openings 34 (see FIG. 1) are provided through the side arms 18, the openings 34 extending centrally through raised annular aligned bosses 35 provided on the outside of both arms 18, The openings 34 on their inner sides are of a hexagonal cross section as at 36 (see FIGS. 1, 6 and 7) to enable a hexagonal nut 36′ to be captured non-rotatably therein. A bolt 37 having an inner hexagonal recess 38 for engagement by an Allen key is received rotatably within a boss 35 and in threaded engagement with a captured nut 36′. When the bolt 37 is tightened, the shank 39 of the bolt 37 is advanced inwardly into the opening or slot 17 for engagement with the adjacent side surface 25 of the shank 24 for a purpose which will be described further below. Of course the bolt 37 may have any form of head for example a hexagonal head to allow for tightening.

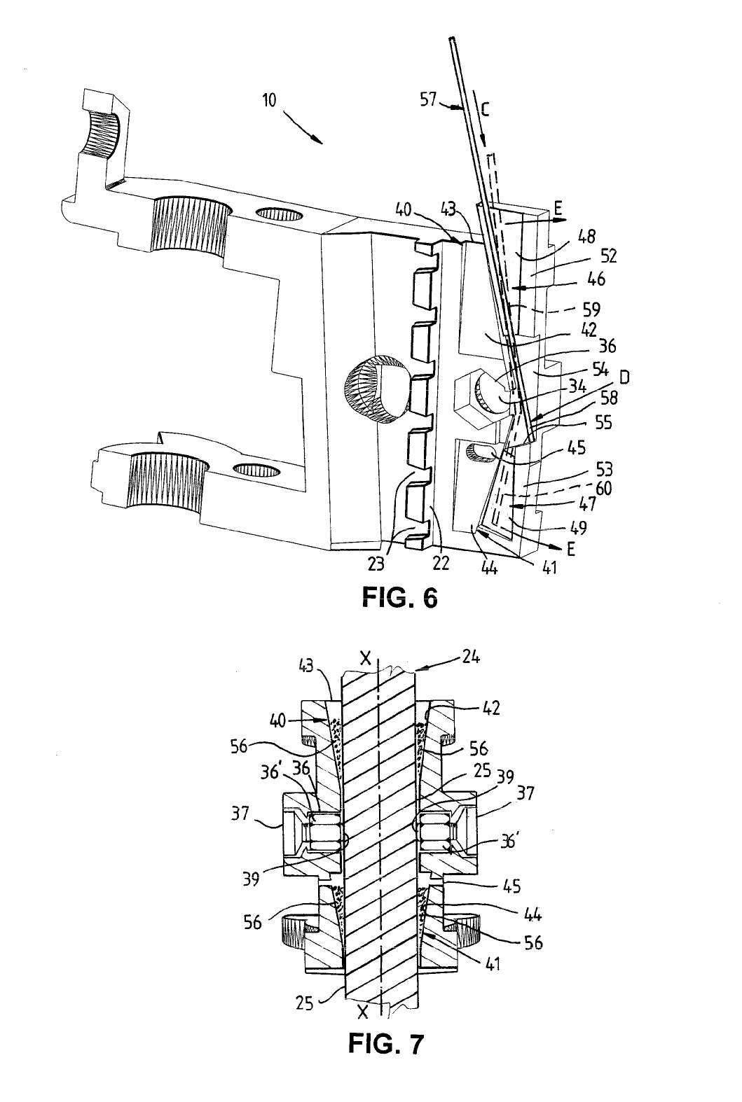

The arms or flanges 18 additionally include on their inner faces sets of opposing upper and lower recesses or rebates 40 and 41 which are located above and below the openings 34 as shown in FIGS. 1 and 6. The upper recesses 40 have inner planar surfaces 42 which are angled inwardly towards the inner sides of the arms 18 from the upper end of the recesses 40 to the lower end of the recesses 40 and the recesses 40 open at 43 at the upper end of the arms 18. The recesses 40 also taper in width so as to be of minimum width at the opening 43 and at a maximum width adjacent the opening 34. The surfaces 43 of opposing recesses 40 thus diverge outwardly relative to the central longitudinal plane through the slot or opening 17 along line A-A towards the upper side of the holder 10

The lower recesses 41 also have planar surfaces 44 which are angled inwardly relative to the central longitudinal plane towards the inner sides of the arms 18 from the upper ends of the recesses adjacent the openings 34 to the lower ends of the recesses 41 however in this case the recesses 41 also taper in width so as to be at a maximum width at their upper ends and at a minimum width at their lower ends. The surfaces 44 of the opposing recesses thus converge inwardly towards each other and in a direction towards the lower side of the holder 10. in addition, transverse openings 45 extend through the arms or flanges 18 to intersect the surfaces 44 to communicate the upper ends of the recesses 41 with the outer side of the arms 18. When the holder 10 is mounted to a shank 24 as in FIG. 4, the faces 42 and 44 define with the opposite side faces 25 of the shank 24 spaces which taper in cross section in the vertical direction from a maximum adjacent the upper ends of the recesses 40 and 41 to a minimum adjacent the lower ends of the recesses 40 and 41 as shown in FIG. 6.

The arms 18 also include on their inner faces further recesses 46 and 47 which are positioned between the recesses 40 and 41 and the outer ends of the arms 18 and which are located above and below the openings 34 (see FIGS. 1,2 and 6). The recesses 46 and 47 have inner faces 48 and 49 which are angled at an acute angle to the central longitudinal plane (along line A-A) through the opening 17 and converge towards each other towards the outer free ends of the arms 18 (see FIG. 5). The faces 48 and 49 are bounded on their inner sides by obtusely angled side surfaces 50 and 51 (see FIGS. 1 and 2) and on their outer sides by inwardly directed aligned ribs 52 and 53 extending along the outer edges of the arms 18. The ribs 52 and 53 are separated by an opening 54 intermediate the upper and lower ends of the arms 18 and the upper ends of the ribs 53 have beveled end surfaces 55 as shown in FIG. 6. The faces 48 and 49 additionally have a maximum width adjacent the upper and lower sides of the arms 18 and a minimum width adjacent the openings 34. Further the upper ends of the arms 18 are extended on their upper sides above the flanges 12 and the surfaces 48 and ribs 52 are also extended in this region. When the holder 10 is mounted to a shank 24 as in FIG. 4, the faces 48 and 49 define with the opposite side faces 25 of the shank 24 spaces which taper in cross section in the fore and aft direction from a maximum adjacent the recesses 40 and 41 to a minimum adjacent the ribs 52 and 53 as is apparent in FIG. 5. The tapering spaces are adapted to receive a wire or rod of resilient material for a purpose which will become apparent below.

In use, the C-shaped opening 19 of the holder 10 is positioned in alignment with the shank track 29 so that the track 29 can be captured in the trailing portion 19 of the slot or opening 17 and the holder 10 is then slid along the shank 24 until the holder 10 is at a desired height as for example shown in FIG. 4. The holder 10 is connected via the pivot pin 16 to a tool or a tool may be connected to the holder 10 via the pin 16 after the holder 10 is secured to the tool shank 24, The flange depressions 23 will mate with the track protrusions 28 at one of a plurality of secure heights for the holder 10 and the wedge member 30 may then be inserted between the track rear surfaces 29 and the holder rear surfaces 20 and secured by means of the bolt 31″ through the opening 33. When the bolt 31″ is tightened, the wedge member 30 will be urged longitudinally of the trailing slot portion 19. The holder 10 will thus be accurately located and securely fixed to the shank 24 and the cooperating V-shaped surfaces of the track 29, the holder 10 and the wedge member 18 provide good load bearing for rearward and forward stresses.

The earth working shank or tyne 24 may then be lowered into the ground and the tyne 24 with attached tool may then be put to use. Soil, dirt or other particulate material in the region of the openings 43 and 45 will naturally enter those openings and start to fill the tapering spaces defined between the surfaces 42 and 44 and side faces 25 of the shank 24 as shown at 56 in FIG. 7. It will be noted from FIG. 7 that the soil or dirt will adopt the configuration of a wedge between the surfaces 42 and 44 and shank surfaces 25 and thus will serve to prevent or resist lateral “wobbling” or twisting of the holder 10 about a generally vertical axis relative to the shank 24. Any relative movement of this nature between the holder 10 and shank 24 will simply result in the soil or dirt in the tapering spaces wedging further downwardly into the tapering spaces and increase the wedging action between the holder 10 and shank 24 and permit further similar materials to enter the tapering spaces.

As an alternative or in addition to the use of the tapering spaces, an elongated member such as a wire or rod 57 of resilient material may be inserted into the upper end of the recess 46 and knocked or hammered downwardly in the direction C as indicated in FIG. 6. The angled surface 48 (and/or the surfaces 50) will direct the lower end 58 of the wire or rod 57 downwardly towards the opening 54 between the ribs 52 and 53 of the holder 10 and towards the angled surface 55 of the rib 53. When the end 58 of the wire or rod 57 strikes the beveled surface 55, the surface 55 will tend to direct the end 58 rearwardly. Continued force applied to the free end of the wire or rod 57 will cause the wire or rod 57 to be deflected rearwardly until it is clear of the surface 55 and moves to the dotted outline position of FIG. 6 adjacent to or abutting the end of the recess 47. Alternatively, a force in the direction D may be applied to the end 58 of the wire or rod 57 through the opening 54 to force the end 58 inwardly to clear the end surface of the 55 of the rib 53 and enable the wire or rod 57 to be driven downwardly until it reaches the closed end of the lower recess 47. It will be appreciated that when in position, the wire or rod 57 will have end portions or legs 59 and 60 which are at an obtuse angle to each other located in the respective recesses 46 and 47 as shown in dotted outline.

The resilient of the wire or rod 57 will cause the legs 59 and 60 thereof to be urged resiliently outwardly in the direction E of FIG. 6 so as to be wedged into the tapering spaces defined between the surfaces 48 and 49 and side surfaces 25 of the shank 24 as also seen in FIG. 5. The wedging action of the wire or rod 57 will also substantially prevent any lateral twisting of wobbling of the holder 10 relative to the shank 24 about a generally vertical axis. Should there be any such movement in use, the resilience of the wire or rod 57 will cause one or both the opposite legs 59 and 60 of the wires or rod 57 to be urged further outwardly in the direction E into the tapering spaces between the surfaces 48 and 49 and shank 24 which may have opened slightly. This will maintain the wedging action provided by the wires or rods 57 and thereby maintain the firm “anti-wobble” connection between the holder 10 and shank 24. The wire or rod 57 is preferably of such a length that in position it projects above the holder 10 as shown in FIGS. 4 and 6 to facilitate its removal.

Additional or alternative resistance to “wobbling” movement of the holder 10 relative to the shank 24 may be achieved by tightening the bolts 37. This will cause the shanks 39 to be urged inwardly into engagement with the opposite side surface 25 of the shank 24 to thereby lock the holder 10 against wobbling movement relative to the shank 24.

Removal of the holder 10 from the shank 24 may be achieved by releasing the bolts 37 (if tightened) and removal of the wires or rods 57 (where used). For this purpose, the bolt 31″ holding the wedge member 30 in position is loosened and an impact force such as a hammer blow may be applied to the plate 31 which will free the wedge member 18 which can then be removed. The tool holder 10 can then be moved forward slightly to permit the disengagement of the protrusions 23 from the depressions 28 which will also free the legs 59 and 60 of the wires of rods 57 so that the wires or rods 57 can be pulled out from the upper end of the holder 10, This will thus free the holder 10 from the shank 24 to allow either complete removal or vertical adjustment of the holder 10, Displacement of the holder 10 from the shank 24 will also allow the soil or dirt 56 to drop from the recesses 40 and 41.

It will be appreciated that the present invention provides a tool holder which can be firmly and easily connected to a shank or tyne at a desired position and which can be rapidly and easily disconnected from the shank. Further the holder can be positioned at any height along a shank or tyne and a range of ground or earth working tools can be connected to the holder.

The anti-wobble arrangements described above may be used singly or in combination. For example, the holder 10 may only incorporate the recesses 40 and 41 for receiving dirt, soil or other particulate material which cooperates in a wedging manner with the shank 24 to prevent lateral twisting or wobbling movement of the holder 10 relative to the shank 24. In this case, the holder does not need to include the recesses 46 and 47 nor the clamping bolts 37. Further the holder 10 may include only one recess 40 or 41.

Alternatively, the recesses 40 and 41 may be eliminated and the holder 10 may only include the recesses 46 and 47 to receive a wedging member 57 for wedging between the holder 10 and shank 24. The holder 10 may also only include one recess 46 or 47 to receive the wedging member 57. In addition, the anti-wobbling arrangements, namely the recesses 40 and 41, 46 and 47 and/or clamp bolts 37 may be provided on only one side of the holder 10 or on both sides thereof. Were the recesses 46 and 47 are used, the wire or rod 57 may be replaced by any elongated member which will perform a wedging action, Such members may be resilient or non-resilient.

Other means may also be provided for setting the height of the holder 10 relative to the shank 24 and locking the holder 10 in that position other than using the wedge connection arrangement using the wedging member 30 as described. In other forms of connection, the shank 24 may not require the grooves 23 and the holder may not require the protrusions 28 to locate the holder 10.

The reference to prior art herein including reference to prior patents is not to be taken as an admission that such prior art constitutes common general knowledge in the art.

The terms “comprising” or “comprises” as used throughout the specification are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as herein defined in the appended claims.

1. A tool holder for mounting a ground or earth working tool to a shank or tyne, said shank or tyne having opposite side surfaces, said tool holder having an opening therethrough adapted to receive the shank or tyne, and wherein said holder includes means adapted to cooperate with at least one said side surface of said shank to prevent or minimize lateral twisting movement of said holder relative to said shank or tyne.

2. A tool holder as claimed in claim 1 and including at least one surface which defines in use with a side surface of the shank a tapering space adapted to receive a material or member which in use is or becomes wedged between the holder and at least one side surface of the shank or tyne to prevent or minimize lateral twisting movement of the holder relative to the shank.

3. A tool holder as claimed in claim 2 wherein said at least one surface comprises a surface which is angled outwardly in a longitudinal direction relative to the longitudinal axis of the opening to define in use with a side surface of the shank, the tapering space.

4. A tool holder as claimed in claim 3 wherein said angled said surfaces are provided on opposite sides of the holder to define in use respective tapering spaces with the respective side surfaces of the shank on opposite sides thereof.

5. A tool holder as claimed in claim 4 wherein the or each angled surface is defined in a recess or rebate in an inner surface or surfaces of the holder which is/are adjacent a side surface/s of the shank or tyne in use.

6. A tool holder as claimed in claim 5 and including at least one upper recess or rebate which opens to and communicates with an upper side of the holder so as to enable the material or member to enter the tapering space defined by the angled surface of the recess from the upper side of the holder.

7. A tool holder as claimed in claim 6 and including at least one lower surface which is angled outwardly relative to the longitudinal axis of the opening to define in use with a side surface/s of the shank or tyne, a further tapering space or spaces.

8. A tool holder as claimed in claim 7 wherein said at least one lower angled surface is provided in at least one lower recess or rebate in said holder which is below the upper recess or recesses.

9. A tool holder as claimed in claim 8 wherein an opening is provided adjacent an upper end of the lower recess to provide communication between the upper end of said recess and the outside of the holder to permit the material or member to enter or locate within the tapering space/s defined in use between the lower recess or recesses and side surface/s of the shank or tyne.

10. A tool holder as claimed in claim 2 wherein said material or member which locates within the tapering space/s comprises soil, dirt or other particulate material from the earth or ground in which the tool is working.

11. A tool holder as claimed in claim 1 and including at least one surface which is angled to a central longitudinal plane through the opening and holder in a fore and aft direction, the angled surface defining in use with a side surface of the shank a space which tapers in cross section for receipt of a wedging member for wedging in the tapering space between the holder and shank or tyne.

12. A tool holder as claimed in claim 11 wherein said wedging member comprises a resilient member.

13. A tool holder as claimed in claim 1 herein said resilient member comprises a wire or rod.

14. A tool holder as claimed in claim 11 and including upper and lower said angled surfaces defining in use with the side surfaces of said tyne or shank upper and lower tapering spaces, said wedging member extending from one tapering space to the other tapering space and having respective end portions or legs in the respective spaces, said wedging member being resiliently stressed such that said opposite end portions or legs in the respective spaces are urged resiliently towards a wedging position.

15. A tool holder as claimed in claim 1 and including at least one clamping screw adapted to be advanced into engagement with an adjacent side surface of the shank to clamp the holder laterally to the shank.

16. A tool mounting assembly for mounting a ground or earth working tool to a shank or tyne, said tool mounting assembly comprising a tool holder having an opening therethrough adapted to receive said shank or tyne, and means adapted to be located between said holder and at least one said side surface of said shank or tyne to prevent or minimize lateral twisting movement of said holder relative to said shank or tyne.

17. A tool mounting assembly as claimed in claim 16 wherein said means for preventing or minimizing lateral twisting movement of the holder relative to the shank or tyne comprises a material or member which in use is or becomes wedged between the holder and at least one side surface of the shank or tyne.

18. A tool mounting assembly as claimed in claim 17 wherein said tool holder includes at least one surface which defines in use with a side surface of the shank a tapering space adapted to receive a wedging material or member.

19. A tool mounting assembly as claimed in claim 18 wherein said tool holder includes at least two said surfaces which define in use with a side surface of the shank, at least two tapering spaces, a first said tapering space tapering in the direction from an upper end of said holder towards a lower end thereof and a second tapering space tapering in a fore and aft direction relative to a front and rear of the holder.

20. A tool mounting assembly as claimed in claim 19 wherein said first tapering space is adapted to receive a particulate material and the second tapering space is adapted to receive the wedging member.

21. In combination, a tool shank or tyne, a tool holder as claimed in claim 20, and means for releasably securing the holder to the shank or tyne at a selected position along the shank or tyne.
